(19) United States
(12) Patent Application Publication
(10) Pub. No.: US 2025/0369898 A1
(43) Pub. Date: Dec. 4, 2025

(54) METHOD FOR INSPECTING SEMICONDUCTOR DEVICE

(71) Applicants: Kabushiki Kaisha Toshiba, Tokyo (JP); Toshiba Electronic Devices & Storage Corporation, Tokyo (JP)

(72) Inventors: Ryoichi OHARA, Himeji Hyogo (JP); Kimihiko KAWANO, Ibo Hyogo (JP)

(21) Appl. No.: 19/035,503

(22) Filed: Jan. 23, 2025

(30) Foreign Application Priority Data
May 31, 2024 (JP) 2024-089162

(51) Int. Cl. G01N 21/95; G01N 21/21; G01N 21/64; G06T 7/00; G06T 7/73; G06T 7/77; G06V 10/60

(52) U.S. Cl. CPC G01N 21/9501; G01N 21/21; G01N 21/6456; G01N 21/6489; G06T 7/001; G06T 7/74; G06T 7/77; G06T 2207/30148; G06V 10/60; G06V 2201/06

(57) ABSTRACT

According to one embodiment, a method for inspecting semiconductor device according to the embodiment includes providing a semiconductor substrate. The method further includes capturing a transmission polarization image of the semiconductor substrate. The method further includes setting coordinate representing respective positions. The method further includes performing image processing on the first image data. The method further includes forming an epitaxial layer. The method further includes forming the plurality of semiconductor elements. The method further includes sequentially performing an electrical inspection on one of a remaining semiconductor elements. The method further includes performing a process of identifying a semiconductor element. The method further includes performing a process of identifying the one of the remaining semiconductor elements.

### CROSS-REFERENCE TO RELATED APPLICATIONS

This application is based upon and claims the benefit of priority from Japanese Patent Application No. 2024-089162, filed on May 31, 2024; the entire contents of which are incorporated herein by reference.

### FIELD

Embodiments generally relate to a method for inspecting semiconductor device.

### BACKGROUND

A silicon carbide (SiC) substrate has a large number of basal plane dislocations (BPDs). It is known that some BPDs propagate to an epitaxial layer after the growth of the epitaxial layer and expand to stacking faults by injection of electrons and holes.

Expansion of the BPDs to the stacking fault causes deterioration in characteristics of the semiconductor devices. There is a demand for removing the BPDs to prevent degradation of the characteristics of the semiconductor device due to the BPDs.

### BRIEF DESCRIPTION OF THE DRAWINGS

FIG. 1 is a schematic block diagram illustrating an inspection system for a semiconductor device;

FIG. 2 is a flowchart illustrating a method for inspecting a semiconductor device according to the embodiment;

FIG. 3A is an example of image data of SiC substrate before an epitaxial layer is formed, which is imaged by a transmission polarization image acquisition device 12;

FIG. 3B is an X-ray topography image of “A part” in FIG. 3A;

FIG. 3C is an X-ray topography image of “B part” in FIG. 3(a);

FIG. 4 is a schematic cross-sectional view showing that BPDs expand after an epitaxial layer is grown on a SiC substrate; and

FIG. 5 is a flowchart illustrating a method for inspecting a semiconductor device according to a modified example of the embodiment.

### DETAILED DESCRIPTION

A method for inspecting semiconductor device according to one embodiment includes providing a semiconductor substrate including silicon carbide. The method further includes capturing a transmission polarization image of the semiconductor substrate by a transmission polarization image acquisition device and converting the transmission polarization image into first image data of a predetermined format. The method further includes setting coordinate representing respective positions on the semiconductor substrate of a plurality of semiconductor elements formed on the semiconductor substrate in the first image data by the transmission polarization image processing device. The method further includes performing image processing on the first image data by the transmission polarization image processing device, and in a case where a luminance at any of a plurality of coordinate is higher than a first luminance or in a case where a luminance at any of the plurality of coordinate is lower than a second luminance, determining and storing the any of the plurality of coordinate as a first defect coordinate. The method further includes forming an epitaxial layer on the semiconductor substrate. The method further includes forming the plurality of semiconductor elements on the semiconductor substrate on which the epitaxial layer is formed. The method further includes sequentially performing an electrical inspection on one of a remaining semiconductor elements corresponding to a remaining coordinate other than the first defect coordinate among the plurality of semiconductor elements based on a preset electrical inspection condition by an electrical characteristic evaluation device, after forming the plurality of semiconductor elements. The method further includes performing a process of identifying a semiconductor element corresponding to the first defect coordinate as being defective without performing the electrical inspection by the electrical characteristic evaluation device. The method further includes performing a process of identifying the one of the remaining semiconductor elements as being defective in a case where the one of the remaining semiconductor elements corresponding to a remaining coordinate other than the first defect coordinate among the plurality of semiconductor elements is determined as being defective in the electrical inspection, and shifting the one of the remaining semiconductor elements to a next step in a case where the one of the remaining semiconductor elements is determined as being within a standard in the electrical inspection.

Hereinafter, embodiments of the present invention will be described with reference to the drawings.

The drawings are schematic or conceptual; and the relationships between the thickness and width of portions, the proportions of sizes among portions, etc., are not necessarily the same as the actual values thereof. The dimensions and proportions may be illustrated differently among drawings, even for identical portions.

In the specification and the drawings, components similar to those described already are marked with like reference numerals, and a detailed description is omitted as appropriate. Each of the embodiments described below may be implemented by inverting the p-type and the n-type of each semiconductor layer.

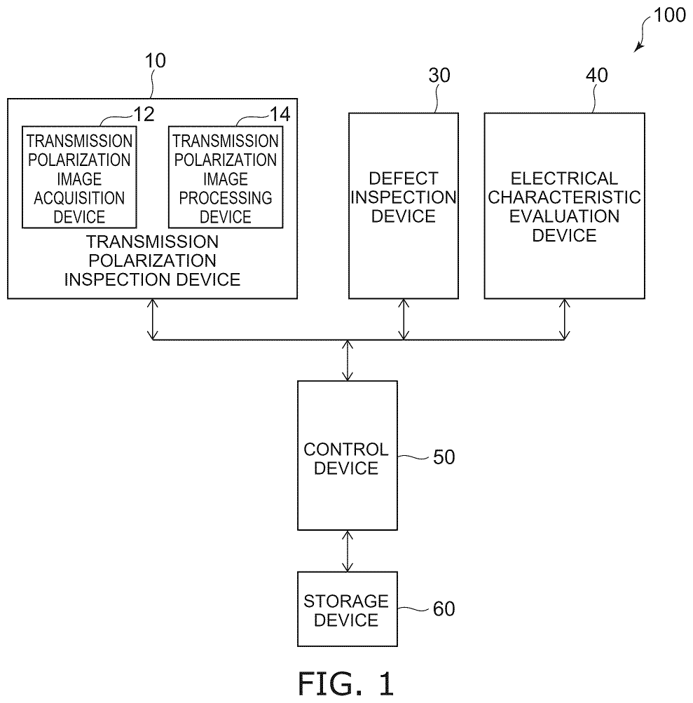

FIG. 1 is a schematic block diagram illustrating an inspection system for a semiconductor device.

As illustrated in FIG. 1, an inspection system 100 includes a transmission polarization inspection device 10, an electrical characteristic evaluation device 40, a control device 50, and a storage device 60. The inspection system 100 may further include a defect inspection device 30 as in a specific example of FIG. 1.

In the inspection system 100, each of the transmission polarization inspection device 10, the defect inspection device 30, and the electrical characteristic evaluation device 40 is communicably connected to the control device 50 via, for example, a control network. Each of the transmission polarization inspection device 10, the defect inspection device 30, and the electrical characteristic evaluation device 40 communicates with the control device 50 to exchange various control signals, data, and the like.

The transmission polarization inspection device 10 includes a transmission polarization image acquisition device 12 and a transmission polarization image processing device 14.

The transmission polarization image acquisition device 12 captures a transmission polarization image which is an image by transmission polarization of a silicon carbide (SiC) substrate (hereinafter referred to as a bulk wafer) before an epitaxial layer is formed. The transmission polarization image acquisition device 12 includes, for example, a light source and an imager (not shown). The light source is constituted by, for example, a light emitting diode that emits ultraviolet light. The light source is disposed on the side of one surface of the bulk wafer via a polarizing plate. The imager is disposed on the other surface side of the bulk wafer. The light from the light source is applied to the bulk wafer via the polarizing plate, and the imager captures a transmission polarization image of the bulk wafer irradiated with the light from the light source.

The transmission polarization image acquisition device 12 converts the captured transmission polarization image into image data (first image data) in a predetermined format, and outputs the image data to the transmission polarization image processing device 14, for example, based on a command from the control device 50.

The transmission polarization image processing device 14 performs image processing on the image data of the transmission polarization image acquired by the transmission polarization image acquisition device 12, determines a defect region (first defect region) of the bulk wafer on the image data, and extracts coordinate (first defect coordinate) included in the defect region. In the image processing, the image data is converted into, for example, luminance data at each coordinate of the image data.

A wafer number for distinguishing the bulk wafer from other bulk wafers is given to the bulk wafer in advance. For example, the wafer number of the bulk wafer is set and managed by the control device 50 and the storage device 60. The image data acquired in the transmission polarization inspection device 10 is associated with the wafer number.

In the inspection system 100, for example, coordinate is set for each bulk wafer. The coordinate of the bulk wafer to be set include a plurality of coordinate specifying respective positions of the plurality of semiconductor elements formed on the bulk wafer. The plurality of coordinate for each bulk wafer are stored in the storage device 60 in association with the wafer number, for example. In the transmission polarization image processing device 14, coordinate is set in the image data so as to correspond to the coordinate on the bulk wafer. That is, the plurality of coordinate of the image data respectively correspond to the plurality of coordinate of the bulk wafer, that is, the positions of the semiconductor elements to be formed. The coordinate of the bulk wafer and the image data may be an absolute coordinate for each semiconductor element or a relative coordinate from a reference position.

The transmission polarization image processing device 14 determines a defect region (first defect region) based on the luminance of the image data of the bulk wafer subjected to the image processing.

The transmission polarization image processing device 14 determines the defect region as follows, for example. That is, the transmission polarization image processing device 14 compares the luminance data of each coordinate of the image data with a preset luminance threshold value (first luminance). The transmission polarization image processing device 14 extracts coordinate at which the luminance data is higher than the luminance threshold value. The transmission polarization image processing device 14 further extracts a plurality of coordinate at which the extracted coordinate is adjacent to each other. The transmission polarization image processing device 14 obtains an area of a region including the extracted plurality of adjacent coordinate. In a case where the area of the region is larger than the preset region threshold value (first region predetermined value), the transmission polarization image processing device 14 determines the region as a defective region.

The region threshold may be set in advance, or may be set for each wafer number and associated with the wafer number.

The luminance threshold value may be set for each wafer number in association with the wafer number of the bulk wafer. The luminance threshold value may be set for each image data of the bulk wafer. In a case where the luminance threshold value is set for each bulk wafer, the luminance threshold value can be calculated by processing the luminance data of the bulk wafer using statistical methods. For example, the luminance data of each coordinate may be acquired from the image data of the bulk wafer, the average value Lav and a standard deviation o of the luminance may be calculated, and Lav+nσ may be set as the luminance threshold value. Here, n is an arbitrary natural number. For example, an appropriate value is set as n by performing an experiment or the like.

As another statistical method, LM+nQ4 obtained by calculating a median LM and a quartile Q4 of the luminance may be used as the luminance threshold value. Here, n is an arbitrary natural number. For example, an appropriate value is set as n by performing an experiment or the like. In addition, the luminance threshold value may be set by using an appropriate statistical method for an outlier of luminance data.

In a determination of the defective region, the defective region may be a region including a plurality of adjacent coordinate having luminance data lower than the preset luminance threshold value (second luminance). In this case, the transmission polarization image processing device 14 obtains the area of the region based on the distance between the coordinate in a case where there are adjacent coordinate having a luminance lower than the luminance threshold value.

The transmission polarization image processing device 14 outputs a plurality of coordinate included in the region determined as the defective region to the control device 50 in association with the wafer number. The control device 50 stores the wafer number and the plurality of coordinate included in the defect region associated with the wafer number in the storage device 60.

The defect inspection device 30 inspects a SiC substrate (hereinafter referred to as an epitaxial wafer) in which an epitaxial layer is formed on a bulk wafer for the presence or absence of defects in the epitaxial layer and/or the bulk wafer. The defect inspection device 30 is, for example, a photoluminescence image inspection device, and inspects the presence or absence of defects on a surface and inside of the epitaxial wafer. Examples of the defects on the surface of the epitaxial wafer include scratches, triangular defects, and linear defects on the surface. The internal defect is BPDs, a stacking fault, or the like.

The defect inspection device 30 acquires, for example, image data (second image data) as data related to the defect acquired by the defect inspection device 30. The defect inspection device 30 determines a defect region (second defect region) based on the photoluminescence intensity at each coordinate of the image data. The defect region is defined by the plurality of adjacent coordinate having intensity data higher than the preset threshold value of photoluminescence intensity.

For example, in a case where the area of a region including adjacent coordinate is larger than the preset threshold value, the defect inspection device 30 sets the region as the defect region. The defect inspection device 30 determines the defect region for each wafer number and extracts the plurality of coordinate (second defect coordinate) included in the defect region. The defect inspection device 30 outputs the extracted plurality of coordinate to the control device 50 in association with the wafer number. The control device 50 updates the data in the storage device 60 by adding the plurality of coordinate included in the defective region to the plurality of coordinate associated with the corresponding wafer number.

The coordinate extracted by the defect inspection device 30 are stored separately from the coordinate extracted by the transmission polarization inspection device 10. The present invention is not limited to this, and these may be stored without distinction. In the present embodiment, it is assumed that these are stored in association with the wafer number without being distinguished from each other.

The electrical characteristic evaluation device 40 performs an electrical inspection of a SiC substrate in which a semiconductor element is formed on an epitaxial wafer (hereinafter, referred to as an element-formed wafer). The electrical characteristic evaluation device 40 performs an electrical inspection of current/voltage characteristics or the like by, for example, probing for each semiconductor device formed on a device-formed wafer, and performs a process of distinguishing between a non-defective product and a defective product of the semiconductor device.

For example, data for electrical inspection for each wafer number is stored in the storage device 60. The storage device 60 stores coordinate r specifying a position of the semiconductor element for each wafer number, for example. Further, the storage device 60 stores the plurality of coordinate included in the defect region determined by the transmission polarization inspection device 10 and the defect inspection device 30 for each wafer number.

The control device 50 outputs data for electrical inspection to the electrical characteristic evaluation device 40 for each wafer number. The electrical characteristic evaluation device 40 sets data for electrical inspection. The data for electrical inspection may be set for each lot number set for each lot including the plurality of wafer numbers or for each product number including the plurality of lots. In the following description, for a sake of simplicity, it is assumed that data for electrical inspection is set for each wafer number.

The control device 50 outputs the coordinate specifying the position of the semiconductor element in the bulk wafer and the plurality of coordinate included in the defect region to the electrical characteristic evaluation device 40. The electrical characteristic evaluation device 40 sets these coordinates.

The electrical characteristic evaluation device 40 inspects the device-formed wafer based on the data for electrical inspection and the data of the plurality of coordinate of the defect region. The data of the electrical inspection includes items of electrical characteristics, measurement conditions for each item of the electrical characteristics, standard values for each electrical characteristic, and the like. The electrical characteristics include, for example, a leakage current, a gate threshold voltage, and a forward voltage drop of the semiconductor element.

For example, the electrical characteristic evaluation device 40 inputs coordinate for specifying the position of the semiconductor element, and sequentially electrically inspects the semiconductor element corresponding to the coordinate in accordance with the input coordinate. The coordinate data for specifying the position of the semiconductor element is not limited to being sequentially input, and may be set in advance in the electrical characteristic evaluation device 40.

In a case where it is determined that the inspected semiconductor element is out of the standard of the data of the electrical inspection, the electrical characteristic evaluation device 40 performs a process of identifying the semiconductor element as defective. The process of identifying a defective product includes, for example, a process of marking the surface of the semiconductor element with ink or the like.

In a case where one of the plurality of coordinate included in the defect region is input, the electrical characteristic evaluation device 40 does not perform the electrical inspection on the semiconductor element corresponding to the coordinate, and marks the surface of the semiconductor element as a process of identifying a defective product.

The marked semiconductor element is image-determined as a defective element in the subsequent assembly process to the package, and is excluded from the assembly.

Alternatively, even in a case where one of the plurality of coordinate included in the defect region is input, the electrical characteristic evaluation device 40 may perform the electrical inspection on the semiconductor element corresponding to the coordinate, and may not mark the surface of the semiconductor element when the semiconductor element is determined to be a non-defective product. This is because even the semiconductor element formed in the defect region may have good electrical characteristics.

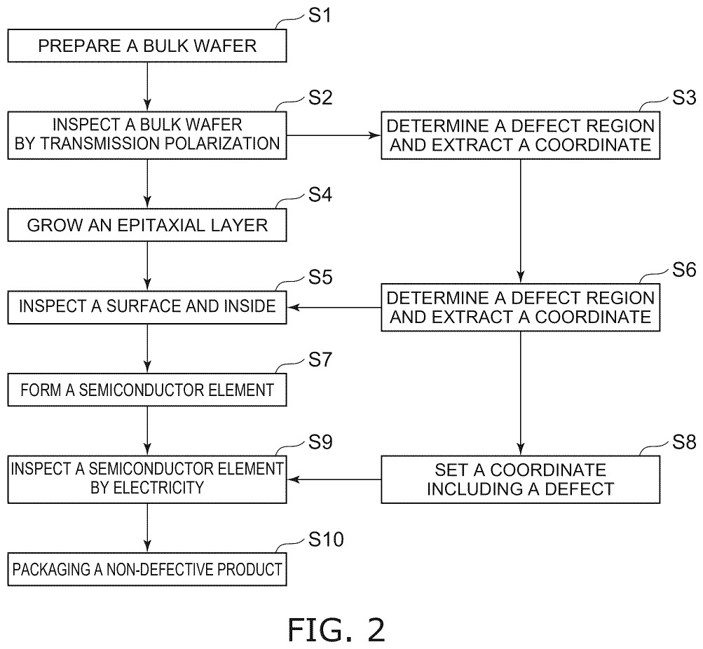

FIG. 2 is a flowchart illustrating a method for inspecting a semiconductor device according to the embodiment.

The above-described series of operations will be described with reference to the flowchart of FIG. 2.

As shown in FIG. 2, in step S1, a bulk wafer is prepared. The prepared bulk wafer corresponds to the wafer number and is distinguished from other bulk wafers.

In step S2, the transmission polarization image acquisition device 12 acquires the image data of the transmission polarization image of the bulk wafer and outputs the acquired image data to the transmission polarization image processing device 14 in association with the wafer number.

In step S3, the transmission polarization image processing device 14 performs image processing on the input image data, determines the defect region (first defect region), and extracts the plurality of coordinate (first defect coordinate) included in the defect region. The transmission polarization image processing device 14 outputs the extracted plurality of coordinate to the control device 50 in association with the wafer number. The control device 50 stores the wafer number and the plurality of coordinate associated with the wafer number in the storage device 60.

In step S4, the bulk wafer that has been subjected to the transmission polarization inspection is subjected to an epitaxial layer forming process. In order to form the epitaxial layer on the bulk wafer, for example, a chemical vapor deposition (CVD) device is used.

In step S5, the defect inspection device 30 acquires data, for example, image data, on defects on the surface and inside of the epitaxial wafer.

In step S6, the defect inspection device 30 performs image processing on each of the image data of the surface and the inside, and determines the defect region (second defect region). The defect inspection device 30 extracts the plurality of coordinate (second defect coordinate) included in the defect region and outputs the coordinate to the control device 50 in association with the wafer number. The control device 50 updates the data in the storage device 60 by adding the plurality of coordinate included in the defective region so as to be associated with the corresponding wafer number.

In step S7, the epitaxial wafer that has been inspected by the defect inspection device 30 is put into the semiconductor element forming process. In the process of forming the semiconductor element, each semiconductor layer, an insulating film, a conductive layer, an electrode, and the like are formed according to the configuration of the semiconductor element.

In step S8, the control device 50 extracts, from the storage device 60, data for electrical inspection associated with the wafer number, coordinate specifying the position of the semiconductor element, and the plurality of coordinate included in the defect region. The control device 50 outputs the data for electrical inspection, the coordinate for specifying the position of the semiconductor element, and, the plurality of coordinate included in the defect region to the electrical characteristic evaluation device 40. The electrical characteristic evaluation device 40 sets the data and the coordinate output from the control device 50.

In step S9, the electrical characteristic evaluation device 40 sequentially inputs the coordinate for specifying the semiconductor elements, and performs the electrical inspection of the semiconductor elements formed on the element formed wafer based on the data (electrical inspection conditions) for the electrical inspection output from the control device 50. By the electrical inspection, for example, the electrical characteristic evaluation the current-voltage device 40 measures characteristics and the like of the semiconductor element formed on the wafer based on the electrical inspection conditions set in advance.

The electrical characteristic evaluation device 40 performs an identification process of a defective product, that is, gives a mark or the like to the semiconductor element determined as a defective product.

In a case where one coordinate of the plurality of coordinate included in the defect region is input, the electrical characteristic evaluation device 40 performs a defective product identification process on the semiconductor element corresponding to the coordinate. Alternatively, in a case where one of the plurality of coordinate included in the defect region is input, the electrical characteristic evaluation device 40 may perform the electrical inspection of the semiconductor element corresponding to the coordinate. Then, only in a case where the result of the electrical inspection is a failure, the defective product identification process may be performed on the semiconductor element corresponding to the coordinate.

In step S10, the device-formed wafer that has been inspected by the electrical characteristic evaluation device 40 is put into a package assembly process. In the package assembly process, the semiconductor device is formed by packaging the semiconductor elements except for the semiconductor elements subjected to the defective product identification process.

The operation and effect of the semiconductor device inspection method according to the embodiment will be described.

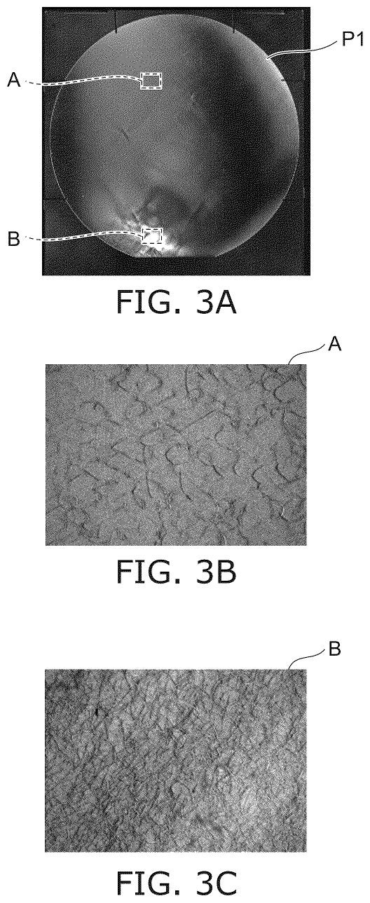

FIG. 3A is an example of image data of SiC substrate before the epitaxial layer is formed, which is imaged by the transmission polarization image acquisition device 12. FIG. 3B is an X-ray topography image of “A part” in FIG. 3A. FIG. 3C is an X-ray topography image of “B part” in FIG. 3A.

As shown in FIG. 3A, in the image data P1 acquired by the transmission polarization image acquisition device 12, a difference in luminance occurs depending on the region.

In FIGS. 3B and 3C, the BPDs are shown as a black curved line.

As shown in FIGS. 3B and 3C, in the image data P1 acquired by the transmission polarization image acquisition device 12, the BPDs are more densely present in a high-luminance region than in a low-luminance region. That is, the transmission polarization image acquisition device 12 acquires the image data P1 and performs image processing on the image data P1 to detect a region having higher luminance than other regions, thereby it is possible to detective region of concentrated BPDs.

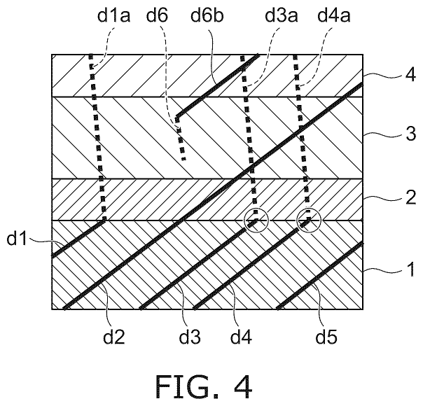

FIG. 4 is a schematic cross-sectional view showing that BPDs expand after the epitaxial layer is grown on the SiC substrate.

In FIG. 4, a layer of the bulk SiC substrate is shown as an n-type substrate 1, and an n-type buffer layer 2 is provided on the n-type substrate 1. An n-type drift layer 3 is provided on the n-type buffer layer 2. A p-type layer 4 is provided on the n-type drift layer 3.

The n-type buffer layer 2 and the n-type drift layer 3 are epitaxial layers formed by epitaxial growth by CVD or the like. The concentration of the n-type impurity in the n-type drift layer 3 is lower than the concentration of the n-type impurity in the n-type substrate 1 and the n-type buffer layer 2. The p-type layer 4 is, for example, a layer containing a p-type impurity formed by an ion implantation method or the like.

By applying a higher voltage to the p-type layer 4 than to the n-type substrate 1, holes, which are minority carriers, are injected from the p-type layer 4 into the n-type drift layer 3. Electrons are supplied from the n-type substrate 1 side, and a current flows between the pn junctions. This current may cause the BPDs to expand into stacking faults.

As shown in FIG. 4, the plurality of BPDs d1 to d5 are formed in the n-type substrate 1. These are generated at the time of manufacturing SiC substrate, and it is difficult to remove them initially.

By forming the n-type buffer layer 2 on the n-type substrate 1, a part of the BPDs is converted into threading edge dislocations (TED). TED do not extend to stacking faults and are formed in the stacking direction, so they can be thought to be harmless dislocations that have little effect on the performance of the semiconductor device. By being provided on the n-type substrate 1, the n-type buffer layer 2 also functions as a recombination layer in which holes injected from the p-type layer 4 recombine with electrons before reaching the n-type substrate 1.

In the example of FIG. 4, among the BPDs d1 to d5 initially formed on the n-type substrate 1, the BPDs d1, d3, and d4 are converted into TED d1a, d3a, and d4a, respectively, in the process of forming the n-type buffer layer 2 by epitaxial growth. On the other hand, the BPDs d2 and d5 are not converted into TED, and can be left to grow to the upper layer in each layer. There are dislocations generated in the process of epitaxial growth, and there may be a small number of cases where TED d6 is converted into the BPDs d6b in the process of epitaxial growth.

In a case where the semiconductor device is, for example, a MOSFET (Metal Oxide Semiconductor Field Effect Transistor), the BPDs does not extend to the stacking fault in a normal operation because the MOSFET is a unipolar device in which either electrons or holes contribute to conduction. In the case of the MOSFET having a vertical structure, the p-type layer of FIG. 4 forms a pn junction together with the n-type drift layer as the p-type base layer, and this pn junction can function as a diode connected in antiparallel to the MOSFET. Under a condition in which the diode operates, holes are injected from the p-type base layer into the n-type drift layer, and thus the BPDs extend to stacking faults.

The stacking fault is, for example, a single Shockley stacking fault. The stacking fault extends in a triangular shape along the c-plane of SiC crystal, for example. The stacking fault is a fault that extends over the plurality of semiconductor layers and prevents majority carriers from traveling through the plurality of semiconductor layers. Therefore, as shown in the image data P1, in a case where the total area of the stacking faults increases, the on-resistance of the MOSFET and the forward voltage drop of the diode increase, which becomes apparent as a decrease in characteristics.

That is, the deterioration of the characteristics of the semiconductor device based on the BPDs does not become apparent until after the operation of the semiconductor device. Therefore, it is difficult to initially find the deterioration and remove the deterioration as a defect. It is technically possible to detect the deterioration of the characteristics by the operation of the semiconductor device and remove the detected deterioration as a defect. However, it is necessary to perform energization screening on all the semiconductor devices, and it is difficult to realize the detection.

Efforts have been made to suppress the occurrence of the BPDs in the manufacturing process of SiC substrates, but it is difficult to stably suppress the occurrence of the BPDs. As a method for detecting the presence of BPDs, an etch pit method and an X-ray topography method are known. The former is a destructive test. In the latter case, the measurement time is long and it is difficult to inspect all the samples. In addition, the scale of the equipment is large and it is more difficult to introduce the equipment as mass production equipment.

As described with reference to FIG. 4, the BPDs are converted into harmless dislocations in the process of forming the epitaxial layer. The BPDs that remains without being converted into harmless dislocations can expand into a stacking fault in use after formation of the semiconductor device. However, even in a case where the BPDs extends to the stacking fault, the performance of the semiconductor device is slightly deteriorated in the case of the area sufficiently smaller than the area of the semiconductor device through which the current flows.

In the SiC substrate before the epitaxial layer is formed, in the region where the density of the BPDs is higher than in other regions, the density of the BPDs remaining in the region after the step of forming the epitaxial layer is high. Therefore, in the region where the density of the BPDs is high, the probability of the BPDs expanding to the stacking fault is also high. In a case where the area of the region where the density of BPDs is high is large, there is a high probability that the performance of the semiconductor device is degraded in a case where the remaining BPDs extend to stacking faults. In the method for inspecting a semiconductor device according to the embodiment, a region with high-density BPDs having an area larger than a predetermined value is detected as a defect region in a SiC substrate before an epitaxial layer is formed. By determining the semiconductor element included in the detected defect region to be defective in advance, it is possible to remove in advance the semiconductor device whose performance may deteriorate after the BPDs is energized after the semiconductor device is formed.

As described with reference to FIG. 3, in the transmission polarization inspection device 10, BPDs concentrated in SiC substrate before the formation of the epitaxial layer can be detected as a change in luminance of the transmitted polarized light image. In the semiconductor device inspection method according to the embodiment, the region of BPDs concentrated is specified as the defect region by performing image processing on the image data of the transmission polarized image of SiC substrate.

The electrical characteristic evaluation device 40 has, as coordinate, positions of the plurality of semiconductor elements formed on the SiC substrate to which the wafer number is given. In the inspection method for the semiconductor device according to the embodiment, the coordinate of the semiconductor element included in the defect region specified by the image data acquired by the transmission polarization inspection device 10 are associated with the wafer number, thereby specifying the semiconductor element which is expanded to the stacking fault and has a high probability that the characteristics deteriorate after energization.

In the method for inspecting a semiconductor device according to the embodiment, the semiconductor element having a high BPDs occurrence density is specified and determined as a defective product in advance, so that the yield as a final semiconductor device after packaging can be improved.

In the method for inspecting a semiconductor device according to the embodiment, defect inspection using be performed by using photoluminescence can also photoluminescence in combination with transmission polarization inspection. The combined use of the transmission polarization inspection and the photoluminescence inspection can improve the detection accuracy of the BPDs. In a SiC substrate, in addition to stacking faults based on the BPDs, dislocations that reduce the performance of the semiconductor device, such as threading screw dislocations, may occur. In the method for inspecting a semiconductor device according to the embodiment, defect inspection using photoluminescence can be performed after the formation of the epitaxial layer.

Also, in the inspection method using photoluminescence, as in the case of the transmission polarization inspection, image data is subjected to image processing to specify the defect region, and coordinate of the semiconductor element included in the defect region are extracted and stored. By excluding the semiconductor element corresponding to the coordinate in this case from the non-defective determination in the wafer inspection, the yield after the semiconductor element formation can be improved.

### Modifications

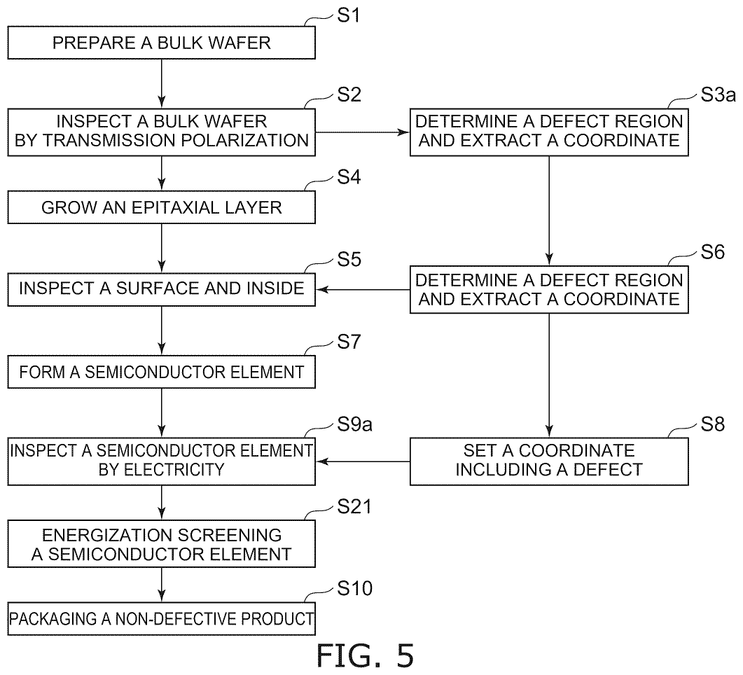

FIG. 5 is a flowchart illustrating a method for inspecting a semiconductor device according to a modification of the embodiment.

In the present modification, the BPDs remaining after the formation of the epitaxial layer are expanded to the stacking faults by energizing the pn junction, and the influence of the expanded faults on the characteristics of the semiconductor element is removed by energization screening. As a result, after the semiconductor device is assembled into the package, the semiconductor element whose characteristics may be deteriorated by the energization screening can be removed in advance, and the reliability of the manufactured semiconductor device can be improved.

The flowchart in FIG. 5 differs from the example shown in FIG. 2 in that steps S3a and S9a are applied instead of the steps S3 and S9 in FIG. 2. The flowchart in FIG. 6 also differs from the example shown in FIG. 2 in that step S21 is executed after the step S9 in FIG. 2, and then the step S10 is executed. Below, the differences are explained in detail, and explanations of the same points are omitted where appropriate.

As shown in FIG. 5, in the step S3a, the transmission polarization image processing device 14 performs image processing on the image data of the transmission polarization image of the bulk wafer acquired by the transmission polarization image acquisition device 12 in the step S2 to determine the defect region. In the determination of the defect region, it is preferable to set the luminance change in a wider range than that in the example of FIG. 2 as the determination condition, for example, the luminance threshold value of Lav+(n−1)σ. As in the example of FIG. 2, in a case where the area of the region including adjacent coordinate having a luminance higher than the threshold value is larger than the preset area threshold value, the transmission polarization image processing device 14 determines the region including these coordinates as the defect region.

In a case where associating the plurality of coordinate included in the defect region with the wafer number, the transmission polarization image processing device 14 associates the plurality of coordinate included in the defect region with the wafer number in distinction from the coordinate specifying the position of the semiconductor element stored in the storage device 60. For example, the transmission polarization image processing device 14 associates the wafer number with the plurality of coordinate included in the defect region after attaching a flag indicating that energization screening is performed.

In step S6, the transmission polarization image processing device 14 associates a plurality of coordinate included in the defect region with the wafer number without setting a flag.

In step S9a, the electrical characteristic evaluation device 40 performs electrical inspection of the semiconductor devices formed on the device-formed wafer based on the data for electrical inspection output from the control device 50. The electrical characteristic evaluation device 40 performs a process of identifying a defective product, for example, providing a mark to the semiconductor element determined as the defective product.

In a case where one coordinate of the plurality of coordinate included in the defect region determined by the image data of the transmitted polarized image is input, the electrical characteristic evaluation device 40 skips the process without performing the inspection of the semiconductor element corresponding to the coordinate and the identification process of the defective product.

In a case where one of the plurality of coordinate included in the defect region determined by the image data of the photoluminescence image is input, the electrical characteristic evaluation device 40 performs the defective product identification processing on the semiconductor element corresponding to the coordinate.

In step S21, the electrical characteristic evaluation device 40 performs energization screening on the plurality of semiconductor elements corresponding to the plurality of coordinate included in the defect region determined by the image data of the transmitted polarized image. In the energization screening, the target semiconductor element is energized so as to continuously flow a current through the pn junction of the semiconductor element under a predetermined condition, and the electrical inspection is performed after a lapse of a predetermined time. The electrical characteristic evaluation device 40 performs the defective product identification process on the semiconductor element determined as the defective product.

In the present modification example, defective products can be removed by performing energization screening on the plurality of semiconductor elements corresponding to the plurality of coordinate included in the defective region determined by image data of the transmitted polarized image before packaging. Therefore, waste of packaging defective products can be eliminated.

The present modification can be applied in combination with the semiconductor device inspection method according to the embodiment described with reference to FIG. 2. That is, for example, in the steps S3 and S3a, the luminance threshold value of the defect region determined by the transmission polarization image processing device 14 is set in two stages. The energization screening is applied to the semiconductor element corresponding to coordinate included in the defect region with low luminance. The energization screening is not applied to the semiconductor elements corresponding to the coordinate included in the high luminance region, and the defective product identification processing is performed.

The configuration of the inspection system 100 illustrated in FIG. 1 is an example, and the configuration is not limited thereto as long as the semiconductor device inspection method according to the embodiment and the modification example thereof can be applied. For example, the storage device 60 may be connected to a control network, and each device may exchange data and the like by a storage medium and the like offline. The image processing device may be an element constituting a part of the transmission polarization inspection device, and the defect inspection device may include another image processor as a part of the defect inspection device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. The above-described embodiments can be implemented in combination with each other.

What is claimed is:

1. A method for inspecting semiconductor device, the method comprising:
providing a semiconductor substrate including silicon carbide;
capturing a transmission polarization image of the semiconductor substrate by a transmission polarization image acquisition device and converting the transmission polarization image into first image data of a predetermined format;
setting coordinate representing respective positions on the semiconductor substrate of a plurality of semiconductor elements formed on the semiconductor substrate in the first image data by the transmission polarization image processing device;
performing image processing on the first image data by the transmission polarization image processing device, and in a case where a luminance at any of a plurality of coordinate is higher than a first luminance or in a case where a luminance at any of the plurality of coordinate is lower than a second luminance, determining and storing the any of the plurality of coordinate as a first defect coordinate;
forming an epitaxial layer on the semiconductor substrate;
forming the plurality of semiconductor elements on the semiconductor substrate on which the epitaxial layer is formed;
sequentially performing an electrical inspection on one of a remaining semiconductor elements corresponding to a remaining coordinate other than the first defect coordinate among the plurality of semiconductor elements based on a preset electrical inspection condition by an electrical characteristic evaluation device, after forming the plurality of semiconductor elements;
performing a process of identifying a semiconductor element corresponding to the first defect coordinate as being defective without performing the electrical inspection by the electrical characteristic evaluation device; and
performing a process of identifying the one of the remaining semiconductor elements as being defective in a case where the one of the remaining semiconductor elements corresponding to a remaining coordinate other than the first defect coordinate among the plurality of semiconductor elements is determined as being defective in the electrical inspection, and shifting the one of the remaining semiconductor elements to a next step in a case where the one of the remaining semiconductor elements is determined as being within a standard in the electrical inspection.

2. The method according to claim 1, further comprising:
capturing a photoluminescence image of an epitaxial substrate including the semiconductor substrate and the epitaxial layer and converting the photoluminescence image into second image data of a predetermined format by a defect inspection device after forming the epitaxial layer on the semiconductor substrate and before forming the plurality of semiconductor elements;
setting the plurality of coordinate in the second image data by the defect inspection device;
performing image processing on the second image data based on the intensities of photoluminescence at the plurality of coordinate, and in a case where an area of a region on the semiconductor substrate in which the intensities of photoluminescence at an adjacent coordinate among the plurality of coordinate are both higher than a third predetermined value is larger than a fourth predetermined value, determining the region as a second defect region, and storing the plurality of coordinate included in the second defect region among the plurality of coordinate as a plurality of second defect coordinate; and
processing to identify the semiconductor elements corresponding to the plurality of second defect coordinate as defective without the electrical inspection by the electrical characteristic evaluation device in the electrical inspection by the electrical characteristic evaluation device after forming the plurality of semiconductor elements.

3. The method according to claim 1, wherein the first luminance and the second luminance are calculated by processing the luminance at the plurality of coordinate by a statistical method.

4. A method for inspecting semiconductor device, the method comprising:
providing a semiconductor substrate including silicon carbide;
capturing a transmission polarization image of the semiconductor substrate by a transmission polarization image acquisition device and converting the transmission polarization image into first image data of a predetermined format;
setting a plurality of coordinate representing positions of a plurality of semiconductor elements formed on the semiconductor substrate in the first image data by the transmission polarization image processing device;
determining a region on the semiconductor substrate as a first defect region including a plurality of first defect coordinate and storing the plurality of first defect coordinate in a case where the first image data is subjected to image processing by the transmission polarization image processing device and an area of a region on the semiconductor substrate in which luminance at an adjacent coordinate among the plurality of coordinate is higher than a first predetermined value is larger than a second predetermined value or an area of a region on the semiconductor substrate in which luminance at the adjacent coordinate is lower than the first predetermined value is larger than the second predetermined value;
forming an epitaxial layer on the semiconductor substrate;
capturing a photoluminescence image of the semiconductor substrate and an epitaxial substrate including the epitaxial layer by a defect inspection device and converting the photoluminescence image into second image data of a predetermined format;
setting the plurality of coordinate in the second image data by the defect inspection device;
performing image processing on the second image data and performing image processing on the first image data based on the intensities of photoluminescence at the plurality of coordinate, and in a case where an area of a region on the semiconductor substrate in which the intensities of photoluminescence at adjacent coordinate among the plurality of coordinate are both higher than a third predetermined value is larger than a fourth predetermined value, determining the region as a second defect region and storing the plurality of coordinate included in the second defect region among the plurality of coordinate as a plurality of second defect coordinate;
forming the plurality of semiconductor elements on the semiconductor substrate on which the epitaxial layer is formed;
sequentially performing an electrical inspection on semiconductor elements other than a semiconductor element corresponding to one of the pluralities of first defect coordinate or one of the pluralities of second defect coordinate among the plurality of semiconductor elements by an electrical characteristic evaluation device based on a preset electrical inspection condition;
determining that a semiconductor element corresponding to the one of the plurality of second defect coordinate among the plurality of semiconductor elements is defective without executing the electrical inspection;
determining whether a semiconductor element corresponding to the one of the plurality of first defect coordinate among the plurality of semiconductor elements is within a standard or defective by performing the electrical inspection by the electrical characteristic evaluation device after performing energization screening in which a current is continuously passed through a pn junction included in the semiconductor element corresponding to the one of the plurality of first defect coordinate;
performing a process of identifying that the semiconductor element corresponding to the one of the plurality of first defect coordinate is defective in a case where the semiconductor element corresponding to the one of the plurality of first defect coordinate among the plurality of semiconductor elements is determined to be defective; and
shifting the semiconductor element corresponding to the one of the plurality of first defect coordinate to a next step in a case where the semiconductor element corresponding to the one of the plurality of first defect coordinate among the plurality of semiconductor elements is determined to be within the standard.
